(19) United States
(12) Patent Application Publication
(10) Pub. No.: US 2019/0047241 A1
(43) Pub. Date: Feb. 14, 2019

(54) DEVICE AND METHOD FOR REMOVING AND SEPARATING COFFEE GROUNDS FROM USED COFFEE CAPSULES

(71) Applicant: Walter Graham Magnus, Narara (AU)

(72) Inventor: Walter Graham Magnus, Narara (AU)

(21) Appl. No.: 15/675,711

(22) Filed: Aug. 12, 2017

(51) Int. Cl. B30B 9/00; B30B 1/00

(52) U.S. Cl. CPC B30B 9/00; B30B 1/00

(57) ABSTRACT

The invention relates to a unit and method for separating the used coffee from biodegradable capsules by removing the coffee grounds therefrom for recycling. The device includes a processing plunger (2) for processing the body of the used capsule (1). The coffee grounds (5) are ejected and are recovered in a second vessel.

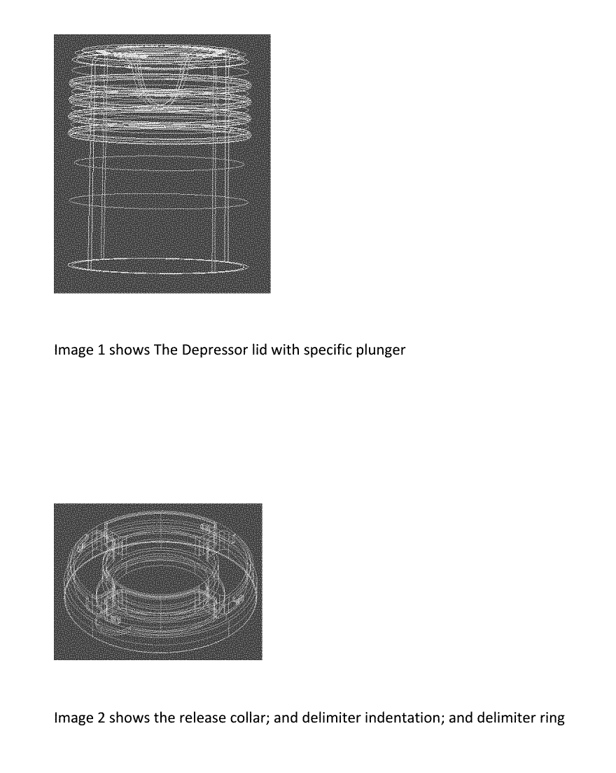

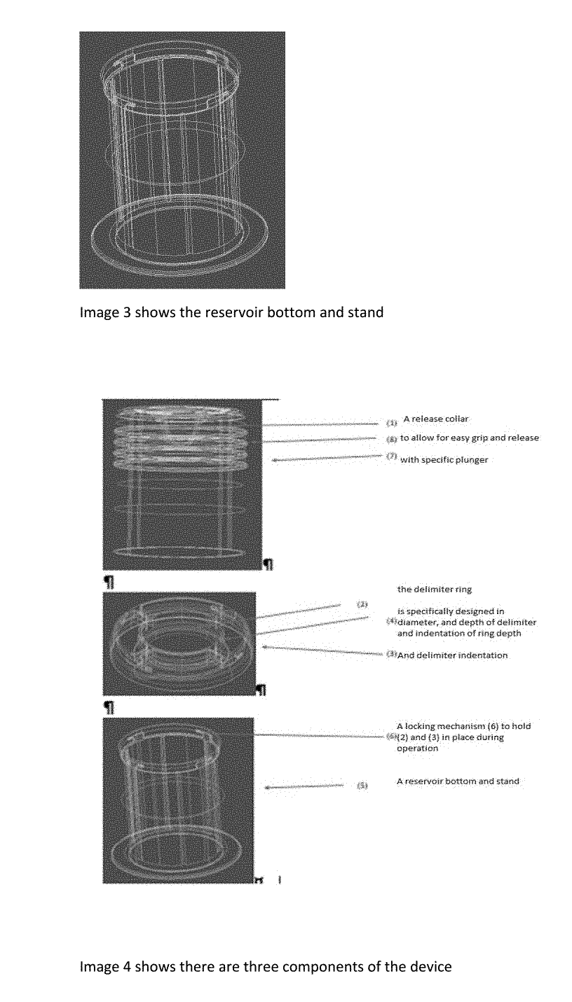

### BACKGROUND OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention relates to a device for discharging of used coffee capsules/pods and reduce the capsule/pod size.

### DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The device comprises: A depressor lid (7) with specific plunger (1). A release collar (3). And delimiter indentation (2) the delimiter ring (4) is specifically designed in diameter, and depth of delimiter and indentation of ring depth;

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents. A reservoir bottom and stand (5).

A locking mechanism (6) to hold (2) and (3) in place during operation. There are rings (8) to allow for easy grip and release.

The method employed allows for the extract of the contents of the capsule/pod and reducing of the capsule/pod for ease of storage and disposal/recycling.

The device allows for the used coffee capsule to be inserted into release collar (3) and delimiter indentation (2) The depressor lid is placed over and depressed. The plunger (1) is engaged and inverts capsule/pod and extracts coffee and resizes capsule/pod. Coffee is released into reservoir (5). The coffee is discharged from (5).

1. A standalone handheld device for emptying of coffee capsules and reduce the size of the capsule/pod. The unit empties the contents of the capsule/pod and decreasing the capsule/pod.
The reservoir bottom and stand, Device according to all the claims.
There are rings (8) to allow for easy grip and release.
